(19) United States
(12) Patent Application Publication
(10) Pub. No.: US 2020/0080912 A1
(43) Pub. Date: Mar. 12, 2020

(54) Verfahren und Vorrichtung zum numerischen Messen mindestens einer strömungsbezogenen Eigenschaft

(71) Applicant: Deutsches Zentrum für Luft- und Raumfahrt e.V., Köln (DE)

(72) Inventor: Axel RAICHLE, Braunschweig (DE)

(21) Appl. No.: 16/559,116

(22) Filed: Sep. 3, 2019

(30) Foreign Application Priority Data
Sep. 4, 2018 (DE) 10 2018 121 519.3

(51) Int. Cl. G01M 9/06; G01M 10/00; G06N 5/02

(52) U.S. Cl. CPC G01M 9/065; G06N 5/02; G01M 10/00

(57) ABSTRACT

The invention relates to a method for the numerical measurement of at least one flow-related characteristic of a profile section of a rotating profile body, around which fluid can flow, by means of a numerical flow simulation which is executed on a data-processing system and which calculates a fluid-based flow around the profile section by means of multi-dimensional computational meshes, wherein the method comprises the following steps:
providing a numerical flow simulation which can be executed on a data-processing system and which is configured such that
   the flow velocity of the far field of the numerical flow simulation is set to zero and, instead, a lattice movement of the multi-dimensional computational mesh is performed with a translational velocity in the profile section plane, such that the relative velocity yields the incident-flow velocity of the profile section at a given angle of attack,
   the symmetry boundary conditions for the edges of the multi-dimensional computational mesh are set to a translationally periodic boundary condition, and
   the velocity component, resulting from the velocity field of the rotational movement on the edge of the profile section, in the normal direction with respect to the profile section plane are taken into consideration in the inertial terms of the balance equations of the numerical flow simulation,
executing the numerical flow simulation as provided above in order to numerically measure and obtain the at least one flow-related characteristic of the profile section.

The invention relates to a method, an apparatus and a computer program for the numerical measurement of at least one flow-related characteristic of a profile section of a rotating profile body, around which fluid can flow, by means of a numerical flow simulation which is executed on a data-processing system and which calculates a fluid-based flow around the profile section by means of multi-dimensional computational meshes.

The shape of rotating profile bodies, around which fluid can flow, such as for example propellers, rotor blades, impellers or repellers or else marine propellers are constructed from profiles in section planes (for short: profile sections) perpendicular to the profile body axis (spanwise extent), the flow-related characteristics (aerodynamic characteristics or hydrodynamic characteristics) of which profiles determine those of the profile body. Only in a subsequent development step is an overall optimization of the profile body as a whole possibly performed, which delivers better results the smaller the deviations of the initial form from the optimum form are.

In Himmelskamp, H.: “Profile investigations on a Rotating Airscrew”, Reports and Translations No 832, AVA 45 A 20, Aerodynamische Versuchsanstalt [aerodynamic research Institute], Göttingen, 1947, it was shown, through the measurement of lift and resistance curves on a rotating impeller blade which was equipped with pressure bores in concentric sections, that rotating profile bodies achieve very much greater maximum lift in the case of a very much greater maximum angle of attack of an incident flow than in the case of a parallel incident flow.

According to the report, similar observations were already made even before this in other experiments. Inertial effects in the boundary layer were considered to be a cause for this characteristic. The report does not suggest the possible form of a method for taking into consideration the influence of the rotation.

The determination of the lift and resistance curves of rotating blade sections in a wind tunnel experiment requires high outlay in terms of measurement technology and encounters the fluid physics problem that, for the determination of the profile characteristics of a profile section, there must be no change in the lift distribution perpendicular to the profile plane. According to the Prandtl vortex model of an airfoil, a change in the lift distribution causes vortices leading away in the spanwise direction, which induce a flow velocity in the profile plane, whereby the incident-flow velocity of the profile and the angle of attack of the chord change relative to the vector of the incident-flow velocity, such that the lift and resistance curves have a different profile. Since the induced velocities of the wake are dependent on the use of the profile, the influence of this effect is undesirable for the determination of the profile characteristics. The form and the influence of the vortex model in the wake are, during the design of a supporting surface, determined from the profile characteristics with the aid of analytical relationships and numerical methods in the field of potential theory.

For the wind tunnel measurement, it remains unknown how the effective angle of attack can be determined without model assumption for a rotating blade section, such that a measured lift and resistance curve corresponds to the lift and resistance curve of a wing of infinite extent. Regarding a theoretical starting point for the handling of rotational effects, the report by H. Himmelskamp describes that, in the light of the difficulties posed by the computational ascertainment of planar boundary layer processes, such a test at present does not promise any practically utilizable results for a complex three-dimensional boundary layer flow.

In the design or re-calculation of profiles for rotating profile bodies, the influence of the rotation is not taken into consideration, or is taken into consideration only heuristically. The flow-related characteristics of a profile or profile section may, under the influence of rotation, deviate considerably from the calculated or the measured characteristics without the influence of the rotation, and the optimum operating point changes. This may have the effect that, as a basis for the design, profile characteristics are used which do not correspond to the physical conditions. In the optimization of a profile section, a form may emerge which, under the given boundary conditions, does not correspond to the optimal form.

With the development of computers, however, numerical flow simulation has been developed, which is based on a direct solution to the system of the fluid mechanics balance equations. Since friction effects and rotational movements can be mathematically described in the balance equations, a starting point is created for the handling of the influence of the rotation on a planar flow around a profile.

Here, in the numerical flow simulation, a multi-dimensional computational mesh, for example a two-dimensional computational mesh, or, in a numerical flow solver for three-dimensional flows, an extruded two-dimensional computational mesh, is used in order to simulate the influence of the profile section on the incident flow. The obvious approach for taking into consideration the influence of the rotation, of rotating a two-dimensional computational mesh or an extruded two-dimensional computational mesh, however does not lead to success. If one initializes the velocity field of a rotation about an axis of rotation that has a finite distance to the mesh plane, lattice velocities arise which become ever greater with increasing distance from the axis of rotation, and a component of which perpendicular to the mesh plane grows proportionally ever greater in relation to the component in the mesh plane. In the case of high rates of rotation of a profile body (for example a propeller or a rotor blade) in conjunction with a large distance of the far field edge to the profile section in the case of a two-dimensional computational mesh, lattice velocities arise which are supersonic and are approximately perpendicular to the mesh plane. This has the effect that a calculation no longer converges.

It is therefore an object of the present invention to specify an improved method and an improved numerical flow simulation with which one or more flow-related characteristics, in particular lift and resistance curves, of profile sections of a rotating profile body around which a fluid can flow can be calculated under the influence of the rotation. It is accordingly an object of the invention to also take the rotation into consideration in the determination of flow-related characteristics of profile sections, the accuracy of which is suitable for optimizing the profile body as a whole in a subsequent optimization step.

The object is achieved according to the invention by means of the method as per claim 1, the measuring apparatus as per claim 9, and the computer program as per claim 11.

According to claim 1, a method is claimed for the numerical measurement of at least one flow-related characteristic of a profile section of a rotating profile body, around which fluid can flow, by means of a numerical flow simulation which is executed on a data-processing system, wherein the numerical flow simulation calculates a fluid-based (aerodynamic or hydrodynamic) flow around the profile section by means of multi-dimensional computational meshes, and in so doing takes into consideration the rotation of the profile body or of the profile section. Here, the numerical flow simulation that can be executed on a data-processing system is configured such that the flow velocity of the far field of the numerical flow simulation is set to zero and, instead, a lattice movement of the multi-dimensional computational mesh is performed with a translational velocity in the profile section plane, such that the relative velocity yields the incident-flow velocity of the profile section at a given angle of attack, that the symmetry conditions for the edges of the multi-dimensional computational mesh are set to a translationally periodic boundary condition, and that the velocity component, resulting from the velocity field of the rotational movement on the edge of the profile section, in the normal direction with respect to the profile section plane are taken into consideration in the inertial terms of the balance equations of the numerical flow simulation. The numerical flow simulation thus configured is then executed with knowledge of the profile section such that the flow-related characteristics of the profile section can be calculated on the basis of the numerical flow simulation. Here, in the execution of the numerical flow simulation, different angles of attack relative to the flow direction of the far field can be taken into consideration, such that this yields, for example, lift and resistance curves for the respective profile section. Here, all inertial terms of the balance equations for viscous three-dimensional flows (for example Navier-Stokes equations) are used in the formulation for rotating computational meshes for the balance equations of inviscid flows for the calculation of a planar fluid-based flow around a rotating profile section with a non-rotating multi-dimensional computational mesh in the numerical flow simulation, wherein those components of the inertial forces in the section plane which arise from the velocity field, resulting from the rotational movement of the edge of the profile section, of the flow in a normal direction with respect to the section plane are significant for the influence of the rotation.

For the calculation of the fluid flow in the section plane of a rotating profile section in a non-rotating computational mesh, in which inertial forces have hitherto remained disregarded, the velocity components in a normal direction with respect to the section plane resulting from the velocity field of the rotational movement of the edge of the profile section, and all inertial terms for the calculation of a three-dimensional flow around a rotating profile body, are taken into consideration. Here, the velocity components in a normal direction with respect to the mesh plane resulting from the velocity field of the rotational movement from the edge of the profile section are taken into consideration, and the inertial terms for a rotating computational mesh are used in a static computation.

The approach according to the invention for taking into consideration the influence of the rotation consists in the components of the flow velocity, and not the lattice velocity of the rotation, being incorporated into the inertial terms of the balance equations. The no-slip condition for a viscous flow in the model of continuum mechanics is determined by the velocity field of the flow at the wall, which need not be identical to the velocity field of the surface of the computational mesh. In the model of continuum mechanics, a no-slip condition exists for a viscous flow at a fixed wall. The velocity field of the flow at the wall must correspond to the velocity field of the wall movement, but need not be identical to the velocity field of the surface of the computational mesh. It should merely be ensured that the relative velocity has no component perpendicular to the surface of the computational mesh. This is the case if the relative velocity vanishes and the movement of the fluid at the wall is identical to the movement of the surface of the computational mesh, or if a sliding movement occurs between the fluid at the wall and the surface of the computational mesh.

This weaker form of the coupling is utilized in the case of sliding walls. For the determination of the profile characteristic, a planar flow state is assumed. For an extruded two-dimensional computational mesh of a profile section, a planar flow state is defined by the gradients of the state variables and of the normal vector with respect to the profile surface having no component perpendicular to the section plane. For a two-dimensional computational mesh, the requirements are satisfied on the basis of the definition. A planar flow state for an extruded two-dimensional computational mesh is, other than with symmetry boundary conditions for the edges parallel to the section plane, also compatible with a translationally periodic continuation of the flow field in a normal direction with respect to the section plane. By contrast to symmetry boundary conditions, a translationally periodic continuation also permits components of the flow velocity in a normal direction with respect to the section plane, and thus the velocity field of the wall movement of a rotating profile section.

In order to avoid excessive velocities, the velocity field of the wall movement of a rotating profile section is divided into the velocity field in the section plane and the velocity field perpendicular to the section plane. The velocity field in the section plane corresponds to the velocity field of a translational movement. Since, in the case of a profile of finite thickness, the relative velocity of a translational movement of the wall relative to the profile surface of the computational mesh can never be tangential to the surface for all normal directions, the relative velocity must vanish, which means that the lattice movement of the computational mesh corresponds to the translational movement of the wall in the section plane. In a normal direction with respect to the section plane, any velocity field is tangential to the profile surface, because the normal vectors of the profile surface lie in the section plane. This is utilized in that no lattice movement takes place normally with respect to the section plane, and the velocity field of the wall movement of the rotating profile section is set in the normal direction with respect to the section plane only for the flow velocity at the wall. Correspondingly to the incident-flow velocity of the profile body in an axial direction, the vector of which lies in the section plane, the translational velocity has a translational velocity superposed on it owing to the rotational movement of the profile body, such that the relative velocity in the section plane corresponds to a given incident-flow velocity and a given angle of attack of the chord in relation to the vector of the incident-flow velocity.

For a numerical flow solver for three-dimensional flows, for example the numerical flow solver Tau, it is standard, for two-dimensional flow calculations, for two-dimensional computational meshes to be extruded such that a mesh composed of a layer of three-dimension elements is realized. To take into consideration the influence of the rotation, for the symmetry boundary conditions for the edges parallel to the mesh plane of the two-dimensional computational mesh, are replaced onto a translationally periodic boundary condition, for which only the periodic information has to be added to the computational mesh.

With the method according to the invention, the lift and resistance curves for the profile sections of the Saab Fairchild Sf-340 model propeller were calculated. It was found that the numerical flow simulation according to the method according to the invention taking into consideration the rotation provides considerably better results than a numerical flow simulation with a parallel incident flow on the profile section.

With the method according to the invention, it is thus possible to numerically examine profile sections of aerodynamic or hydrodynamic profile bodies with regard to their aerodynamic or hydrodynamic characteristics, wherein the influence of the rotation on such rotating profile bodies is also taken into consideration, and it is thus also possible to numerically confirm the results and findings of Himmelskamp (see above). In this way, cumbersome tests in wind tunnels are eliminated, wherein an overall optimization of the profile body can be performed already at the development stage prior to the construction of a first prototype. In this way, development times are shortened and utilized more efficiently. Furthermore, the costs for the development of a profile body are reduced, because an overall optimization of the profile can now be performed already prior to the first construction of a prototype, and not only thereafter.

By means of the numerical measurement method, it is thus possible for aerodynamic or hydrodynamic characteristics of a profile section to be determined which cannot be obtained by means of physical measurement methods without the aid of additional model assumptions. In the context of the present invention, numerical measurement is to be understood to mean the determination of flow-related characteristics without using measurement sensors.

In one advantageous embodiment, the translational velocity of the lattice movement of the (extruded) two-dimensional computational mesh is made up of the path velocity of the rotational movement at the distance of the section plane from the axis of rotation and a movement in the direction of the axis of rotation.

In a further advantageous embodiment, those velocity components in a normal direction with respect to the section plane of the profile section which emerge from the velocity field of the rotational movement of the profile edge are taken into consideration. Those velocity components which emerge from the velocity field of the rotational movement of the edge are, owing to the viscosity of a viscous flow, transmitted to a greater or lesser extent into the flow field around the edge, and these components are also taken into consideration, such that the velocity field comprises not only the components of the wall movement. For the points of the profile edge, respectively different distances from the axis of rotation exist, whereby the velocity vectors vary over the entire edge. The change in the velocity vectors on the edge also results in a change in the components in a normal direction with respect to the section plane, which increase with increasing distance from the plane perpendicular to the section plane through the axis of rotation.

It is advantageous for a lift coefficient, a resistance coefficient, a moment coefficient, a lift curve (lift coefficient versus the angle of attack), a resistance curve (resistance coefficient versus the angle of attack), a polar (lift coefficient versus the resistance coefficient with the angle of attack as parameter) and/or a moment curve (moment coefficient versus the angle of attack) to be numerically measured as flow-related characteristics of the profile section.

The rotating aerodynamic profile bodies around which flow can pass, the profile sections of which profile bodies are to be examined, may for example be a propeller blade, rotor blade, impeller blade or repeller blade. Here, consideration is given in particular to profile bodies of helicopters, wind turbines, turbines, propeller aircraft and impellers.

In a further advantageous embodiment, the rotating profile body around which fluid can flow is broken down into one or more profile sections, wherein one or more flow-related characteristics are determined for each profile section, and wherein one or more flow-related characteristics of the rotating profile body around which fluid can flow are determined from the respective flow-related characteristics of the individual profile sections. Accordingly, from the flow-related characteristics of the individual profile sections that have been numerically measured with the aid of the present method according to the invention, the flow-related characteristics of the entire profile body can be derived, and thus for example lift, resistance and/or moment curves of the profile body can be determined.

The object is furthermore also achieved according to the invention by means of the measuring apparatus according to claim 9, wherein the measuring apparatus comprises a data-processing system on which a numerical flow simulation which has the above-stated characteristics can be executed. The geometrical data of the respective profile section, the distance of the section plane from the axis of rotation, the angular velocity of the rotation and the angle of attack of the chord in relation to a plane perpendicular to the axis of rotation are then transmitted to the measuring apparatus, wherein the numerical flow simulation executed on the measuring apparatus then calculates the corresponding flow-related characteristics.

The invention will be discussed by way of example on the basis of the appended figures, in which:

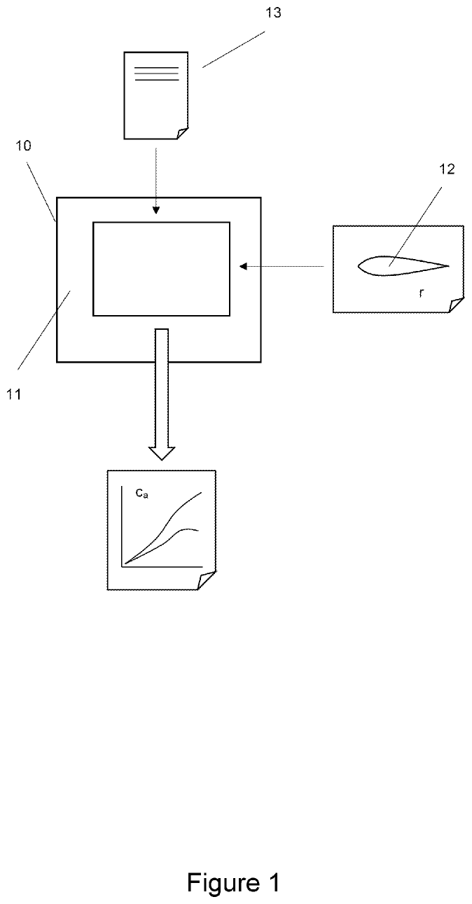

FIG. 1—is a schematic illustration of the measuring apparatus according to the invention;

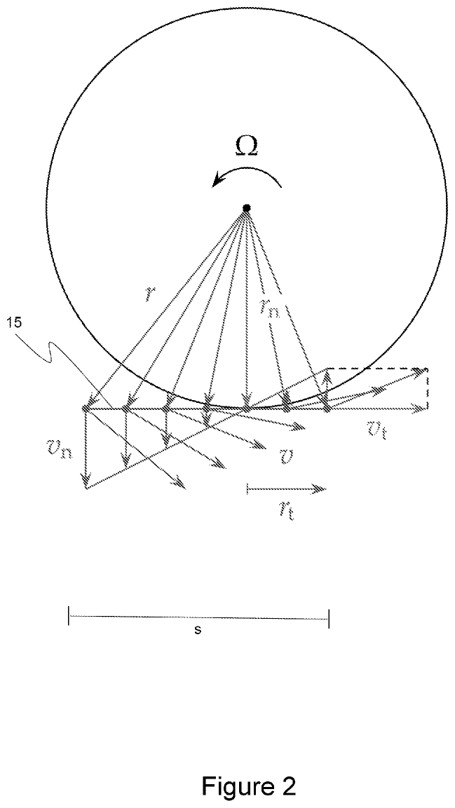

FIG. 2—is a schematic illustration of the velocity field of a profile section of finite extent arranged at an angle of attack, in the projection onto a plane perpendicular to the axis of rotation;

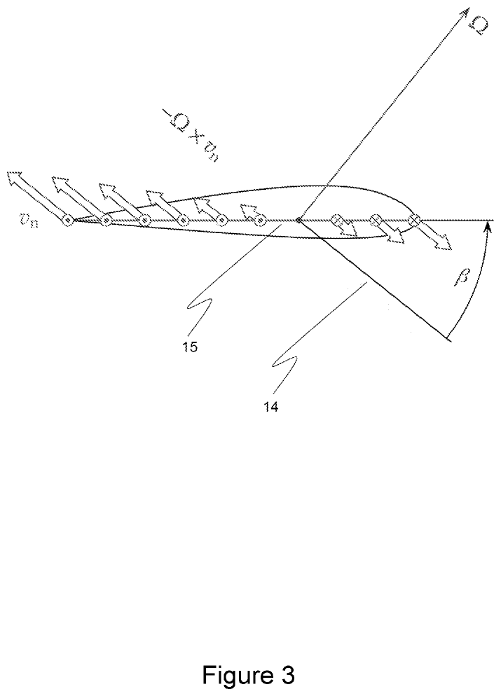

FIG. 3—is a schematic illustration of the components of the mass-specific inertial forces on the edge of the profile section in the section plane, projected onto the chord.

FIG. 1 shows the measuring apparatus 10, which is in the form of a data-processing system and on which a numerical flow simulation 11 is executed or executable. As input data, the numerical flow simulation of the measuring apparatus 10 firstly receives the shape of the profile section 12 of the profile body to be examined, the radius rₙ that describes the distance of the section plane of the profile section from the axis of rotation of the rotating profile body, the angular velocity Ω of the rotation, and the angle of attack β of the chord relative to a plane perpendicular to the axis of rotation.

Furthermore, the numerical flow simulation 11 receives further input data 13 which are intended to become the basis of the numerical flow simulation. These may be for example the incident-flow velocity and the graduation of the angles of attack that are to be examined.

The numerical flow simulation now calculates, for example, the lift curve of the profile, which constitutes the lift coefficient cₐ as a function of the angle of attack α of the chord relative to the vector of the incident-flow velocity. For this purpose, the numerical flow simulation is firstly executed for a specific angle of attack α, and the flow-related (aerodynamic) coefficients of the chord are determined. The flow-related (aerodynamic) coefficients may for example be the lift coefficient cₐ, the resistance coefficient c_{w} or the moment coefficient cₘ. For different angles of attack α, these yield the lift curve, the resistance curve and the moment curve.

For a section plane which rotates at the constant angular velocity Ω at the distance rₙ from the axis of rotation, FIG. 2 illustrates the velocity field of the rotational movement of the edge in the projection onto a plane perpendicular to the axis of rotation. The velocity field is temporally constant relative to the section plane. For a vanishing extent s of the profile section in the plane perpendicular to the axis of rotation, the velocity field lies in the section plane and is also spatially constant; it corresponds to a translational movement of the edge with the vector vₜ of the path velocity on the circular path at the distance rₙ from the axis of rotation.

For a finite extent s of the profile in the plane perpendicular to the axis of rotation, the velocity field of the translational movement with the path velocity vₜ has superposed on it a temporally constant velocity field which is perpendicular to the profile plane and which increases linearly with the distance rₜ to the plane perpendicular to the profile plane through the axis of rotation. For the calculation of the lift and resistance curve of the profile without taking into consideration the influence of the rotation, the extent s of the profile section in the plane perpendicular to the axis of rotation is disregarded, and the lift and resistance curves are calculated with a parallel incident flow, the velocity of which corresponds to the oppositely oriented path velocity −vₜ in the section plane, which can be supplemented by a corresponding component in the case of a forward movement in the direction of the axis of rotation.

To obtain a numerical method for taking into consideration the influence of the rotation, a formulation of the balance equations of the model of continuum mechanics for rotating computational meshes is used, which was developed in Kroll, N.: “Berechnung von Strömungsfeldern um Propeller und Rotoren im Schwebeflug durch die Lösung der Euler-Gleichungen” [“Calculation of flow fields around propellers and rotors in hovering flight by solving the Euler equations”], Dissertation, Faculty of Mechanical Engineering and Electrical Engineering at the Carolo-Wilhelmina Technical University of Braunschweig, 1989, and which is used in the numerical flow solver Tau in order to calculate three-dimensional flows around rotating profile bodies. In this formulation, the flow velocity v in the inertial system is not divided into a relative velocity with respect to a rotating reference system and a velocity of the rotating reference system with respect to the inertial system, but instead, the change in the flow velocity of the inertial system with respect to a rotating reference system is considered. Normally, a position vector r in the inertial system is broken down into the position vector r₀ with respect to the origin of the rotating reference system and the position vector rᵣ from the origin to a point of the rotating reference system that performs a rotational movement, the change in position of which at a time t₀ is described by the transformation matrix T

r=r₀+Trᵣ.

Deriving this relationship with respect to time, one obtains the relative velocities

$$\frac{\partial r}{\partial t} = \frac{\partial {r}_{0}}{\partial t} + \underbrace{\frac{\partial T}{\partial t}}_{Ω \times } {r}_{r} + \underbrace{T}_{I} \frac{\partial {r}_{r}}{\partial t} .$$

In the balance equations, the derivation is considered at the respectively present point in time t₀=O, at which a change in position does not yet occur owing to the rotation. In this case, the transformation matrix T for the rotation is identical to the unit matrix I, and the matrix vector product with the derivative with respect to time of the transformation matrix T for the rotation can be represented as a cross product with the vector of the angular velocity Ω. By means of a further derivation of this relationship with respect to time t, one obtains the centripetal and the Coriolis acceleration, which relate to the position vector rᵣ and the velocity vᵣ=drᵣ/dt in the rotating reference system. In the alternative formulation, the division of the flow velocity v in the inertial system is omitted, and only the change thereof with respect to time with respect to the rotating reference system is considered. Inserting the velocity vector v into the relationship of the above-stated formula, one obtains

$$\frac{\partial v}{\partial t} = \underbrace{\frac{\partial T}{\partial t}}_{Ω \times } v + \underbrace{T}_{I} \frac{\partial v}{\partial t} .$$

such that the relative acceleration Ω×v is obtained as the only additional term. The product of the relative acceleration Ω×v with the density ρ arises, in the derivative with respect to time of the volume integral, on the left-hand side of the momentum equation, which, as a vectorial equation, comprises three scaler equations for the three spatial directions. If this term is moved to the right-hand side of the momentum equations, it can be interpreted, with a negative sign, as a volume-specific inertial force.

If a profile moves through an inviscid flow which is at rest relative to the inertial system, the additional acceleration term Ω×v is equal to zero, and the rotation has no influence if the flow velocity owing to the displacement is disregarded.

A mass-specific inertial force in the rotating reference system is equal to the negative relative acceleration −Ω×v. FIG. 3 shows the section plane of the profile section and the projection of the axis of rotation onto the section plane. The mass-specific inertial forces that act on the edge of the profile section are illustrated in FIG. 3 in the projection onto the chord. The mass-specific inertial forces vanish at the points of intersection of the edge with the plane perpendicular to the section plane through the axis of rotation, and increase linearly with the distance rₜ to said plane. Decelerating mass-specific inertial forces arise in front of said plane, and accelerating mass-specific inertial forces arise behind said plane. The mass-specific inertial forces have the angle of attack β relative to the chord, which is identical to the angle of attack of the chord relative to a plane perpendicular to the axis of rotation.

The mass-specific inertial forces act in the section plane in the boundary layer of the flow. The boundary layer of the flow constitutes a thin layer in the vicinity of the edge of the profile section, in which viscous forces play a role. The inertial forces in the section plane arise owing to the velocity field of the rotational movement of the edge in a normal direction with respect to the section plane, which propagates into the flow field of the boundary layer owing to viscous forces. In FIG. 3, the normal components of the flow velocity are illustrated in the projection of the mass-specific inertial forces of the edge onto the chord. A cross corresponding to the fin of an arrow indicates that the velocity components are directed away from the viewer normally with respect to the profile plane; a dot corresponding to an arrow tip shows that the velocity components are directed towards the viewer normally with respect to the profile plane. The plane of the drawing corresponds to the section plane.

The inertial terms that have hitherto been used for the calculation of a three-dimensional flow around a rotating profile body using a rotating computational mesh are used for the calculation of a planar flow around a profile section using a non-rotating two-dimensional extruded computational mesh. The inertial forces in the section plane that arise from the velocity field normal to the section plane, as shown in FIG. 3, are responsible for a correct representation of the influence of the rotation and the resulting flow-related characteristics. The inertial forces have, in the rear part of the profile section, a component in the flow direction, which component counteracts the deceleration of the boundary layer owing to the pressure increase and thus prevents a premature detachment of the flow. In the front part of the profile section, the inertial forces have a component counter to the flow direction, which component counteracts the acceleration of the boundary layer owing to the displacement of the flow, and the associated pressure drop. Since the flow is intensely accelerated in this region, the components counter to the flow direction do not lead to a detachment of the flow. By taking into consideration the inertial forces of a three-dimensional flow field in the calculation of a planar flow around a profile, in which velocity components are present in all spatial directions, secondary effects of the inertial forces in the boundary layer are also taken into consideration.

### LIST OF REFERENCE DESIGNATIONS

10 Measuring apparatus

11 Numerical flow simulation

12 Profile section

13 Input data

14 Plane perpendicular to the axis of rotation

15 Chord

1. A method for measurement of at least one flow-related characteristic of a profile section of a rotating profile body, around which fluid can flow, comprising:
executing a numerical flow simulation on a data-processing system; and
calculating a fluid-based flow around the profile section using one or more multi-dimensional computational meshes,
wherein the numerical flow simulation and the data-processing system are configured such that
a flow velocity of a far field of the numerical flow simulation is set to zero and, instead, a lattice movement of the one or more multi-dimensional computational meshes is performed with a translational velocity in a profile section plane, such that a relative velocity yields an incident-flow velocity of the profile section of the rotating body at a given angle of attack,
symmetry boundary conditions for edges of the one or more multi-dimensional computational meshes are set to a translationally periodic boundary condition, and
a velocity component resulting from a velocity field of a rotational movement on an edge of the profile section in a normal direction with respect to the profile section plane are taken into consideration in inertial terms of balance equations of the numerical flow simulation.

2. The method according to claim 1, wherein the at least one flow-related characteristic is an aerodynamic characteristic of the rotating profile body, or a hydrodynamic characteristic of the rotating profile body.

3. The method according to claim 1, wherein the translational velocity of the lattice movement is comprised of
a path velocity of the rotational movement at a distance of the profile section plane from an axis of rotation, and
a movement in a direction of the axis of rotation.

4. The method according to claim 1 wherein for the numerical flow simulation, a two-dimensional computational mesh is used which is extruded in a normal direction with respect to a computational mesh plane, such that a computational mesh of said one or more multidimensional computational meshes is formed from a layer of three-dimensional elements.

5. The method according to claim 1 wherein along a chord of the profile section consideration is given to a multiplicity of velocity components in the normal direction with respect to the profile section plane which arise from a velocity field over the chord.

6. The method according to claim 1 wherein the calculating step includes calculating from the velocity component in the normal direction with respect to the profile section plane, resulting from the velocity field of the rotational movement on the edge of the profile section, at least one volume-specific inertial force, wherein the at least one volume-specific inertial force is taken into consideration in the inertial terms of the balance equation.

7. The method according to claim 1 wherein a lift coefficient, a resistance coefficient, a moment coefficient, a lift curve, a resistance curve, and a polar and/or a moment curve are numerically measured as flow-related characteristics of the profile section.

8. The method according to claim 1 wherein the rotating profile body around which fluid can flow is a propeller blade, a rotor blade, an impeller blade, a repeller blade, or the blade of a marine propeller.

9. The method according to claim 1 wherein the rotating profile body around which fluid can flow is constituted from a multiplicity of individual profile sections, wherein at least one flow-related characteristic is determined for each individual profile section, and wherein at least one flow-related characteristic of the rotating profile body around which fluid can flow is determined from the respective flow-related characteristics of the individual profile sections.

10. A measuring apparatus for measurement of at least one flow-related characteristic of a profile section of a rotating profile body around which fluid can flow, comprising:
a data-processing system on which a numerical flow simulation is executed which calculates a fluid-based flow around the profile section using one or more multi-dimensional computational meshes, wherein the data-processing system and the numerical flow simulation are configured such that
a flow velocity of a the far field of the numerical flow simulation is set to zero and, instead, a lattice movement of the one or more multi-dimensional computational meshes is performed with a translational velocity in a profile section plane, such that a relative velocity yields an incident-flow velocity of the profile section at a given angle of attack,
symmetry boundary conditions for edges of the one or more multi-dimensional computational meshes are set to a translationally periodic boundary condition, and
a velocity component resulting from the velocity field of a rotational movement on an edge of the profile section, in a normal direction with respect to the profile section plane are taken into consideration in inertial terms of balance equations of the numerical flow simulation.

11. The measuring apparatus according to claim 10, wherein the measuring apparatus is configured for carrying out the method according to claim 1.

12. A non-transient computer readable medium encoded with a computer program which, when executed on a data-processing system, performs the method of claim 1.
